(19) United States
(12) Patent Application Publication
(10) Pub. No.: US 2010/0309270 A1
(43) Pub. Date: Dec. 9, 2010

(54) INKJET-RECORDING MEDIUM AND INKJET-RECORDING METHOD USING SAME

(75) Inventors: Hirokazu SHIMADA, Shizuoka (JP); Hideki KAIMOTO, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/858,798

(22) Filed: Aug. 18, 2010

Related U.S. Application Data
(62) Division of application No. 12/260,205, filed on Oct. 29, 2008.

(30) Foreign Application Priority Data
Oct. 31, 2007 (JP) 2007-283097

(51) Int. Cl. B41J 2/01

(52) U.S. Cl. 347/102

(57) ABSTRACT

To provide an inkjet-recording medium including a water non-absorptive support, and an ink-receiving layer which is formed over at least one surface of the water non-absorptive support and which contains inorganic microparticles, wherein the ink-receiving layer has an ink-absorption capacity of 2 mL/m² to 8 mL/m².

### BACKGROUND OF THE INVENTION

1. Field of the Invention

The present invention relates to an inkjet-recording medium and an inkjet-recording method using the inkjet-recording medium.

2. Description of the Related Art

With the recent rapid development of the IT industry; various information-processing systems have been developed, including inkjet-recording methods, heat-sensitive recording methods, pressure-sensitive recording methods, photosensitive recording methods, and transfer recording methods. In addition, there have been developed and used various recording devices suitable for use in these information-processing systems. Among these recording methods, inkjet-recording methods have been widely used not only in offices but also in homes. This is because they allow printing on various recording materials, and the hardware (device) therefor is relatively cheap, compact, and silent.

In addition, the recent high-resolution inkjet printers realize printing of so-called photo-like, high-quality images. With the advancement of the hardware (device), a variety of inkjet-recording media have been developed.

In general, such an inkjet-recording medium is required, for example, to (1) exhibit high dry speed (high ink-absorbing speed), (2) achieve appropriate, uniform ink-dot diameter (no ink bleeding), (3) attain favorable ink-dot graininess, (4) achieve high ink-dot circularity, (5) attain high ink-color density, (6) achieve high ink-color saturation (free of dullness), (7) impart excellent water-, light- and ozone-resistances to printed image portions, (8) have high whiteness, (9) have good storage stability (no yellowing and image-bleeding after long-term storage), (10) have resistance to deformation; i.e., excellent dimensional stability (sufficiently suppressed curling) and (11) exhibit excellent hardware travel performance.

Further, if the inkjet-recording medium is used as gloss photo paper (which is used for printing so-called photo-like, high-quality images), in addition to the above properties, there are also demanded, for example, glossiness, glossiness of printed image portions, surface smoothness, texture comparable to silver-halide photographic printing paper.

In an attempt to improve the aforementioned properties, recently, there has been developed and practically used inkjet-recording media having an ink-receiving layer (recording layer) with a porous structure (see, for example, Japanese Patent Application Laid-Open (JP-A) Nos. 10-119423 and 10-217601). Such inkjet-recording media have excellent ink-receiving property (quick-drying property) by virtue of its porous structure, providing high-gloss images.

In general, inkjet-recording media have an ink-receiving layer with large ink-absorption capacity (i.e., large amount of inorganic microparticles coated on per unit area of inkjet-recording media), and thus curling and/or cracking may occur during inkjet recording.

In addition, in use of an inkjet recording system where an acidic substance-containing treatment liquid is applied, when recording media used for the inkjet recording have large ink-absorption capacity, applied acidic substances are absorbed and lost from the surface of the ink-receiving layer. As a result, ink components cannot easily aggregate, and the image quality may drop.

### BRIEF SUMMARY OF THE INVENTION

The present invention aims to solve the above problems pertinent in the art and to achieve the following objects. Specifically, an object of the present invention is to provide an inkjet-recording medium which can prevent generation of curling and cracking and maintain desired image quality and ink-absorbability, and an inkjet-recording method using the inkjet-recording medium.

Means for solving the foregoing problems are as follows:

<1> An inkjet-recording medium including:

a water non-absorptive support, and

an ink-receiving layer which is formed over at least one surface of the water non-absorptive support and which contains inorganic microparticles,

wherein the ink-receiving layer has an ink-absorption capacity of 2 mL/m² to 8 mL/m².

<2> The inkjet-recording medium according to <1> above, wherein the ink-receiving layer has a void volume ratio of 50% or higher.

<3> The inkjet-recording medium according to any one of <1> and <2> above, wherein the inorganic microparticles contained in the ink-receiving layer are vapor-phase-method silica with an average primary particle diameter of 30 nm or less, and the ink-receiving layer contains a hydrophilic binder in an amount of 50% by mass or less with respect to the vapor-phase-method silica.

<4> An inkjet-recording method including:

printing on the inkjet-recording medium according to any one of <1> to <3> above with ink in accordance with given image data, and

drying for removing the solvent of ink that has been printed on the inkjet-recording medium.

<5> An inkjet-recording method including:

applying an acidic substance-containing treatment liquid to the inkjet-recording medium according to any one of <1> to <3> above,

printing on the inkjet-recording medium with ink in accordance with given image data, and

drying for removing the solvent of ink that has been printed on the inkjet-recording medium.

The present invention can provide an inkjet-recording medium which can prevent generation of curling and cracking and maintain desired image quality and ink-absorbability, and an inkjet-recording method using the inkjet-recording medium. These can solve the above problems pertinent in the art and achieve the above objects.

### BRIEF DESCRIPTION OF THE SEVERAL VIEWS OF THE DRAWINGS

FIG. 1 is an explanatory illustration of a recording medium of the present invention.

FIG. 2 is an explanatory illustration of a first inkjet-recording method using the recording medium of the present invention.

FIG. 3 is an explanatory illustration of a second inkjet-recording method using the recording medium of the present invention.

### DETAILED DESCRIPTION OF THE INVENTION

Referring now to the drawings, next will be described an inkjet-recording medium of the present invention and an inkjet-recording method using the inkjet-recording medium.

### (Inkjet-Recording Medium)

An inkjet-recording medium of the present invention includes a water non-absorptive support and an ink-receiving layer and, if necessary, further includes other appropriately selected layers.

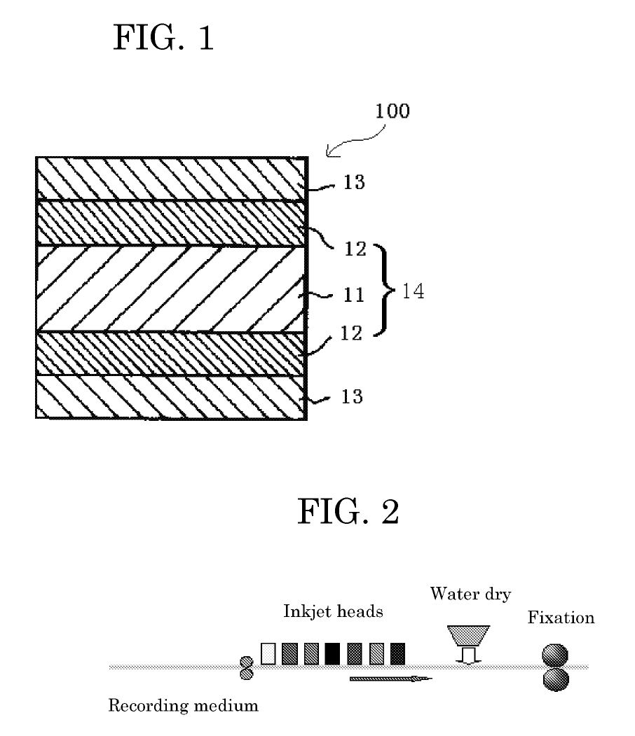

For example, as shown in FIG. 1, an inkjet-recording medium 100 has a water non-absorptive support (resin-coated paper) 14 formed of raw paper 11 and polyethylene layers 12, and ink-receiving layers 13 formed on the polyethylene layers 12. Notably, FIG. 1 is a non-limitative example of the present inkjet-recording medium where ink-receiving layers 13 are formed on both surfaces of the water non-absorptive support. That is, an ink-receiving layer 13 may be formed on one surface of the support.

### <Water Non-Absorptive Support>

The water non-absorptive support used in the present invention has a Cobb-water absorption degree of 5.0 g/m² or lower that is a value obtained through measurement according to the water absorption test stipulated in JIS P8140 (1998 ed.) at a water contact time of 15 sec. The Cobb-water absorption degree is preferably 1.0 g/m² or lower, more preferably 0 g/m². As described above, the Cobb-water absorption degree is measured by the water absorption test according to JIS P8140. In this test, one surface of a water non-absorptive support is brought into contact with water in a certain time, and the amount of water absorbed by the support is measured. Note that the contact time was set to 15 sec.

The water non-absorptive support used in the present invention may be a transparent support formed of a transparent material (e.g., plastic) or an opaque support formed of an opaque material (e.g., resin-coated paper and synthetic paper). Use of a transparent support or an opaque, high-gloss support is preferable, for making full use of the transparency of the ink-receiving layer. It is also possible to use, as the water non-absorptive support, read-only optical discs (e.g., CD-ROM and DVD-ROM), write-once optical discs (e.g., CD-R and DVD-R), or rewritable optical discs, and form an ink-receiving layer on the label face thereof.

Preferably, the above transparent support can be formed of a transparent material capable of enduring radiant heat applied during use in OHPs and backlight displays. Examples of the material include polyesters (e.g., polyethylene terephthalate (PET)), polysulfones, polyphenylene oxides, polyimides, polycarbonates and polyamides. Of these, polyesters are preferable, with polyethylene terephthalate being particularly preferable.

The thickness of the transparent support is not particularly limited, and is preferably 50 μm to 200 μm from the viewpoint of allowing easy handling.

The above opaque, high-gloss support is preferably those where the surface on which the ink-receiving layer is to be formed has a glossiness of 40% or higher. The glossiness is a value determined according to the method described in JIS P-8142 (test method for specular gloss of paper and paperboard at 75°).

Specific examples thereof include the following water non-absorptive supports; e.g., opaque, high-gloss films prepared by incorporating white pigment or the like into plastic films formed, for example, of polyesters (e.g., polyethylene terephthalate (PET)), polysulfones, polyphenylene oxides, polyimides, polycarbonates or polyamides (the films being optionally subjected to a surface calender treatment); high-gloss paper supports such as art paper, coat paper, cast coat paper and baryta paper used for a silver-halide photographic support; and water non-absorptive supports prepared by providing the surface of the above transparent supports or high-gloss films containing white pigment or the like with a coating layer made of polyolefin optionally containing white pigment.

In addition, white pigment-containing foamed polyester films (e.g., foamed PET containing polyolefin microparticles and voids formed through stretching) are preferably used. Furthermore, resin-coated paper used for silver-halide photographic printing paper is also preferably used.

The thickness of the opaque support is not particularly limited, and is preferably 50 μm to 300 μm from the viewpoint of handleability.

The surface of the water non-absorptive support may be treated with, for example, a corona discharge treatment, glow discharge treatment, flame treatment or UV ray irradiation treatment for improving wettability and adhesiveness.

### <<Resin-Coated Paper>>

### —Raw Paper—

Next will be described in detail raw paper used for forming resin-coated paper.

The raw paper is made from a mixture mainly containing wood pulp and optionally containing synthetic pulp (e.g., polypropylene) and/or synthetic fiber (e.g., nylon and polyester). Examples of the wood pulp include LBKP, LBSP, NBKP, NBSP, LDP, NDP, LUKP and NUKP. Preferably, the wood pulp mixture contains a larger amount of LBKP, NBSP, LBSP, NDP and/or LDP, each containing a lot of short fibers.

The relative LBSP and/or LDP amount with respect to the mixture is preferably 10% by mass to 70% by mass.

Also, chemical pulp containing few impurities (sulfate or sulfite pulp) is preferably used. Furthermore, bleached pulp with improved whiteness is useful.

The raw paper may appropriately contain, for example, a sizing agent (e.g., higher fatty acids and alkyl ketene dimers), a white pigment (e.g., calcium carbonate, talc and titanium oxide), a paper strengthening agent (e.g., starch, polyacrylamide and polyvinyl alcohol), a fluorescent whitening agent, a water retention agent (e.g., polyethylene glycols), a dispersant, and/or a softening agent (e.g., quaternary ammoniums).

The freeness of the pulp used for papermaking is preferably 200 mL to 500 mL according to the CSF. Preferably, the pulp obtained after beating has a fiber length (as measured according to JIS P-8207) satisfying the following: a total of a 24-mesh-screen-remnant and a 42-mesh-screen-remnant is from 30% by mass to 70% by mass, and a 4-mesh-screen-remnant is 20% by mass or less.

The basis weight of the raw paper is preferably 30 g to 250 g, particularly preferably 50 g to 200 g. The thickness thereof is preferably 40 μm to 250 μm. Also, the raw paper can be provided with high smoothness by performing a calender treatment during or after papermaking. The density thereof is generally 0.7 g/m² to 1.2 g/m² as measured according to JIS P-8118.

In addition, the strength of the raw paper is preferably 20 g to 200 g as measured according to JIS P-8143.

The surface of the raw paper may be coated with a surface-sizing agent. The surface-sizing agent may be identical to that incorporated into the raw paper. Preferably, the pH of the raw paper is 5 to 9 as measured by a hot-water extraction method according to JIS P-8113.

### —Polyethylene Layer—

The front and back surfaces of the raw paper are coated, in many cases, with low-density polyethylene (LDPE) and/or high-density polyethylene (HDPE). In addition, LLDPE, polypropylene, etc. may be used.

The polyethylene layer on the side where the ink-receiving layer is to be formed is made preferably from polyethylene having improved opaqueness, whiteness and hue through addition of rutile- or anatase-type titanium oxide, a fluorescent whitening agent or an ultramarine blue pigment (this treatment is widely performed for forming photographic printing paper). The relative titanium oxide amount with respect to polyethylene is preferably about 3% by mass to about 20% by mass, more preferably 4% by mass to 13% by mass. The thickness of the polyethylene layers on the front and back surfaces is not particularly limited. Preferably, it is 10 μm to 50 μm. Optionally, an undercoat layer may be formed on the polyethylene layer to improve its adhesiveness to the ink-receiving layer. The undercoat layer is made preferably from aqueous polyester, gelatin or PVA. The thickness thereof is preferably 0.01 μm to 5 μm.

The polyethylene-coated paper may be used as gloss paper. Alternatively, like general-use photographic printing paper, it may be provided with a matte surface or a silk-finish surface by performing embossing when polyethylene is melt-extruded onto the raw paper surface.

The water non-absorptive support may be provided with a back-coat layer. The back-coat layer may contain a white pigment, an aqueous binder and other components.

Examples of the white pigment contained in the back-coat layer include inorganic white pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate and magnesium hydroxide; and organic pigments such as styrene plastic pigments, acrylic plastic pigments, polyethylene, microcapsules, urea resins and melamine resins.

Examples of the aqueous binder contained in the back-coat layer include water-soluble polymers such as styrene/maleate copolymers, styrene/acrylate copolymers, polyvinyl alcohol, silanol-modified polyvinyl alcohol, starch, cationic starch, casein, gelatin, carboxymethyl cellulose, hydroxyethyl cellulose and polyvinyl pyrrolidone; and water-dispersible polymers such as styrene-butadiene latex and acrylic emulsion. Examples of the other components contained in the back-coat layer include defoamers, foaming-suppressing agents, dyes, fluorescent whitening agents, antiseptic agents and water-proofing agents.

### <Ink-Receiving Layer>

The ink-receiving layer is not particularly limited, so long as it is formed over at least one surface of the water non-absorptive support, contains inorganic microparticles, and has an ink-absorption capacity of 2 mL/m² to 8 mL/m², and can be appropriately selected depending on the purpose. Preferably, the void volume ratio thereof is 50% or more. Also, the layer preferably contains a hydrophilic binder, and optionally contains other components.

### <<Inorganic Microparticles>>

Examples of the inorganic microparticles include silica microparticles, colloidal silica, titanium dioxide, barium sulfate, calcium silicate, zeolite, kaolinite, halloysite, mica, talc, calcium carbonate, magnesium carbonate, calcium sulfate, pseudo-boehmite, zinc oxide, zinc hydroxide, alumina, aluminum silicate, calcium silicate, magnesium silicate, zirconium oxide, zirconium hydroxide, cerium oxide, lanthanum oxide and yttrium oxide. Of these, silica microparticles, colloidal silica, alumina microparticles and pseudo-boehmite are preferred from the viewpoint of forming an excellent porous structure. The above microparticles may be used in the form of primary or secondary particles, and preferably have an average primary particle diameter of 2 μm or less, more preferably 200 nm or less.

In addition, more preferred are silica microparticles with an average primary particle diameter of 20 nm or less, colloidal silica with an average primary particle diameter of 30 nm or less, alumina microparticles with an average primary particle diameter of 20 nm or less, and pseudo-boehmite with an average pore radius of 2 nm to 15 nm. Particularly preferred are such silica microparticles, such alumina microparticles and such pseudo-boehmite.

In general, silica microparticles are classified roughly into wet-method particles and dry-method (vapor-phase-method) particles depending on the production method therefor. In the wet method, generally, a silicate is decomposed with an acid to produce an active silica, and the active silica is polymerized to a suitable extent to form aggregated/precipitated hydrous silica. The vapor-phase methods are classified roughly into the flame hydrolysis process and the arc method. In the flame hydrolysis process, generally, a silicon halide is hydrolyzed in a vapor phase at high temperature to form anhydrous silica microparticles; and in the arc method, generally, quartz and coke are reduced and vaporized in an electric furnace by applying arc discharge, followed by air oxidation, to thereby form anhydrous silica microparticles. As used herein, the “vapor-phase-method silica” refers to anhydrous silica microparticles produced by the above-described vapor-phase method. In the present invention, the vapor-phase-method silica microparticles are preferably used.

The vapor-phase-method silica has different properties from the hydrous silica. This is because, for example, the former silica contains voids unlike the latter silica, and also, they are different in the density of silanol groups present on the surface. The vapor-phase-method silica is more suitable for forming a three-dimensional structure with high void volume ratio. The reason for this is supposedly as follows: hydrous silica microparticles have a higher density of silanol groups present on their surfaces (about 5 groups to 8 groups/nm²), leading to dense gathering (aggregation); in contrast, vapor-phase-method silica microparticles have a lower density of silanol groups present on their surfaces (about 2 groups to 3 groups/nm²), leading to loose gathering (flocculation) and thus forming a three-dimensional structure with high void volume ratio.

The vapor-phase-method silica microparticles, among others, have a high specific surface area and therefore, exhibit high ink-absorbability and high ink-retentability. In addition, the silica microparticles have a low refractive index and thus, when they are sufficiently dispersed to reach an appropriate particle diameter, the ink-receiving layer can be provided with transparency, attaining higher color density and favorable coloring. The transparency of an ink-receiving layer is important for applications requiring transparency; e.g., in use as OHP sheets. In addition, even in use as a recording sheet such as gloss photo paper, the transparency thereof is important from the viewpoint of attaining high color density and favorable coloring property.

From the viewpoint of imparting desired quick-drying property (high ink-absorbing speed) to the ink-receiving layer, the inorganic microparticles (e.g., vapor-phase-method silica) preferably have an average primary particle diameter of 30 nm or less, more preferably 3 nm to 30 nm, particularly preferably 3 nm to 20 nm, most preferably 3 nm to 10 nm. The vapor-phase-method silica microparticles are easier to stick to one another via hydrogen bonds formed by silanol groups, and those with an average primary particle diameter of 50 nm or less can form a structure having high void volume ratio and can effectively enhance ink-absorbability. Thus, use thereof is preferred.

The vapor-phase-method silica may be used in combination with the other inorganic microparticles. In this case, the vapor-phase-method silica content of all the microparticles is preferably 30% by mass or more, more preferably 50% by mass or more.

Other preferred examples of the inorganic microparticles used in the present invention include alumina microparticles, alumina hydrates, mixtures thereof and composites thereof. Among them, alumina hydrates are preferred, since they exhibit good ink-absorbability and ink-fixing property, with pseudo-boehmite (Al₂O₃.nH₂O) being particularly preferred. Alumina hydrates may be in various forms. Preferably, boehmite sol is used, since a smooth layer can be easily obtained.

The pseudo-boehmite with a pore structure preferably has an average pore radius of 1 nm to 30 nm, more preferably 2 nm to 15 nm; and preferably has a pore volume of 0.3 cc/g to 2.0 cc/g, more preferably 0.5 cc/g to 1.5 cc/g. The pore radius and pore volume are measured using the nitrogen adsorption/desorption method. In this measurement, for example, there can be used a gas adsorption/desorption analyzer (e.g., “Omnisoap 369” (trade name), product of Coulter, Inc.). Also, among alumina microparticles, vapor-phase-method alumina microparticles are preferred, since they have a large specific surface area. The vapor-phase-method alumina microparticles preferably have an average primary particle diameter of 30 nm or less, more preferably 20 nm or less.

The above-described microparticles can be preferably used in inkjet-recording media in a manner described, for example, in JP-A Nos. 10-81064, 10-119423, 10-157277, 10-217601, 11-348409, 2001-138621, 2000-43401, 2000-211235, 2000-309157, 2001-96897, 2001-138627, 11-91242, 08-2087, 08-2090, 08-2091, 08-2093, 08-174992, 11-192777 or 2001-301314.

### <<Ink-Absorption Capacity>>

The ink-absorption capacity is determined by the following measuring method. Specifically, an inkjet-recording medium is cut into test pieces of 10 cm×10 cm; diethylene glycol (1 mL) is dropped on the ink-receiving layer of the test pieces; unabsorbed diethylene glycol remaining on the layer is wiped up; and the ink-absorption capacity (mL/m²) is calculated from the specific gravity of ethylene glycol and the difference between the masses before and after drop.

### <<Void Volume Ratio>>

The void volume ratio is determined by the following measuring method.

Specifically, a cross-section of an ink-receiving layer is observed with an electron microscope to determine the layer thickness; and the void volume ratio is calculated from the obtained thickness and the above ink-absorption capacity.

### <<Hydrophilic Binder (Water-Soluble Binder)>>

Examples of the hydrophilic binder contained in the ink-receiving layer include polyvinyl alcohol resins having a hydroxyl group as a hydrophilic structural unit (e.g., polyvinyl alcohols (PVAs), acetoacetyl-modified polyvinyl alcohols, cationic modified polyvinyl alcohols, anionic modified polyvinyl alcohols, silanol-modified polyvinyl alcohols and polyvinylacetals); cellulose resins (e.g., methyl cellulose (MC), ethyl cellulose (EC), hydroxyethyl cellulose (HEC), carboxymethyl cellulose (CMC), hydroxypropyl cellulose (HPC), hydroxyethylmethyl cellulose and hydroxypropylmethyl cellulose); chitins; chitosans; starch; ether bond-containing resins (e.g., polyethylene oxide (PEO), polypropylene oxide (PPO), polyethylene glycol (PEG), and polyvinyl ether (PVE)); and carbamoyl group-containing resins (e.g., polyacrylamide (PAAM), polyvinyl pyrrolidone (PVP) and polyacrylic hydrazide).

Other examples include compounds having a carboxyl group as a dissociative group (e.g., polyacrylic acid salts, maleic acid resins, alginic acid salts and gelatins).

Of these, polyvinyl alcohol resins are particularly preferred. Examples of the polyvinyl alcohol include those described in Japanese Patent Application Publication (JP-B) Nos. 04-52786, 05-67432 and 07-29479, Japanese Patent No. 2537827, JP-B Nos. 07-57553, 2502998 and 3053231, JP-A No. 63-176173, JP-B No. 2604367, JP-A Nos. 07-276787, 09-207425, 11-58941, 2000-135858, 2001-205924, 2001-287444, 62-278080, 09-39373, JP-B No. 2750433 and JP-A Nos. 2000-158801, 2001-213045, 2001-328345, 08-324105 and 11-348417.

Examples of hydrophilic binders other than the polyvinyl alcohol resins include those described in paragraphs [0011] to [0014] of JP-A No. 11-165461. These hydrophilic binders may be used alone or in combination.

In the present invention, the hydrophilic binder content is preferably 9% by mass to 40% by mass, more preferably 12% by mass to 33% by mass, based on the total solid content of the ink-receiving layer.

The inorganic microparticles and the hydrophilic binder, which mainly constitute the ink-receiving layer in the present invention, may individually be formed from a single material or a mixture of two or more materials. Notably, transparency of the ink-receiving layer depends greatly on the type of the hydrophilic binder used in combination with the inorganic microparticles (in particular, silica microparticles). When vapor-phase-method silica microparticles are used, polyvinyl alcohol resins are preferably used in combination. In particular, those with a saponification degree of 70% to 100% are more preferred, and those with a saponification degree of 80% to 99.5% are particularly preferred.

The polyvinyl alcohol resins contain a hydroxyl group as a structural unit. The hydroxyl groups form hydrogen bonds together with the silanol groups present on silica microparticles, which easily forms a three-dimensional network structure having, as the network structure unit, secondary particles of the silica microparticles. This three-dimensional network structure is thought to contribute to formation of a porous ink-receiving layer having high void volume ratio and sufficient mechanical strength.

During inkjet recording, the porous ink-receiving layer can rapidly absorb inks through capillarity, and can provide printed dots excellent in circularity without ink bleeding.

The polyvinyl alcohol resins may be used in combination with the other hydrophilic binders described above. In this case, the polyvinyl alcohol resin content of all the hydrophilic binders is preferably 50% by mass or more, more preferably 70% by mass or more.

### <<Content Ratio of Inorganic Microparticles to Hydrophilic Binder>>

The film structure and film strength of the ink-receiving layer depend greatly on the content ratio by mass of the inorganic microparticles (x) to the hydrophilic binder (y) (PB ratio (x/y)). In general, as the PB ratio increases, the void volume ratio, pore volume and surface area (per unit mass) increase, but the density and strength tend to decrease.

In the present invention, the PB ratio (x/y) of the ink-receiving layer is preferably 1.5 to 10. When the PB ratio is too large, the film strength is reduced and cracking occurs during drying. Whereas when the PB ratio is too small, voids are easily filled with resin to decrease the void volume ratio, causing reduction in the ink-absorbability.

The ink-receiving layer is required to have sufficiently high film strength. This is because a stress may be applied thereto during transfer through a conveying system; and cracking, peeling, etc. thereof may occur when the inkjet-recording medium is cut into sheets. Considering the above, the ratio (x/y) is preferably 5 or less. Meanwhile, from the viewpoint of ensuring high-speed ink absorbability when the inkjet-recording medium is used in inkjet printers, the ratio is more preferably 2 or more.

For example, in the case where vapor-phase-method silica microparticles with an average primary particle diameter of 20 nm or less and a hydrophilic binder are homogeneously dispersed in an aqueous solution at a ratio (x/y) of 2 to 5 to prepare a coating liquid, and the coating liquid is coated on a water non-absorptive support, followed by drying, a three-dimensional network structure having, as the network structure unit, secondary particles of the silica microparticles is formed. Thus, there can be easily formed a translucent porous film with an average pore diameter of 30 nm or less, void volume ratio of 50% to 80%, specific pore volume of 0.5 mL/g or more, and specific surface area of 100 m²/g or larger.

Also, when a hydrophilic binder is used in combination with vapor-phase-method silica microparticles having an average primary particle diameter of 30 nm or less, the amount of the hydrophilic binder is 50% by mass or less with respect to the vapor-phase-method silica microparticles.

### <<Other Components>>

The other components are not particularly limited and can be appropriately selected depending on the purpose. Examples thereof include crosslinking agents capable of crosslinking the hydrophilic polymers, cationic polymers, water-soluble polyvalent metal compounds (water-soluble polyvalent metal salts), mordants and surfactants.

### <Other Layers>

The other layers are not particularly limited and can be appropriately selected depending on the purpose.

### <Production Method for Inkjet-Recording Medium>

A production method for an inkjet-recording medium of the present invention includes a coating liquid preparation step and a coating step, and if necessary, includes appropriately selected other steps.

### <<Coating Liquid Preparation Step>>

The coating liquid preparation step is not particularly limited, so long as an inorganic microparticles-containing coating liquid is prepared, and can be appropriately selected depending on the purpose. The coating liquid may optionally contain a hydrophilic binder, a crosslinking agent capable of crosslinking the hydrophilic binder, a cationic polymer, a water-soluble polyvalent metal compound (water-soluble polyvalent metal salt), a mordant, a surfactant, etc.

### <<Coating Step>>

The coating step is not particularly limited, so long as the prepared coating liquid is coated on the water non-absorptive support, and can be appropriately selected depending on the purpose.

### <<Other Steps>>

The other steps are not particularly limited and can be appropriately selected depending on the purpose. Examples thereof include a treatment liquid-applying step.

### (Inkjet-Recording Method)

An inkjet-recording method of the present invention includes a step of printing with ink (ink-printing step) and a drying step, and if necessary, includes appropriately selected other steps.

### <Ink-Printing Step>

The ink-printing step is not particularly limited, so long as ink-printing is carried out in accordance with given image data, and can be appropriately selected depending on the purpose.

### <Drying Step>

The drying step is not particularly limited, so long as the solvent of ink that has been printed on recording media is removed by drying, and can be appropriately selected depending on the purpose.

### <Other Steps>

The other steps are not particularly limited and can be appropriately selected depending on the purpose. Examples thereof include a treatment liquid-applying step.

### <<Treatment Liquid-Applying Step>>

The treatment liquid-applying step is not particularly limited, so long as a treatment liquid containing an acidic substance given below is applied, and can be appropriately selected depending on the purpose.

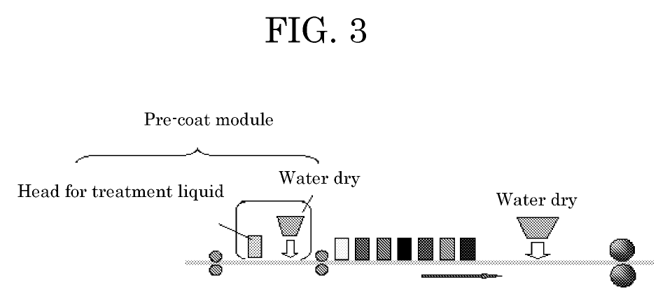

Examples of the inkjet-recording method include inkjet-recording methods 1 (FIG. 2) and 2 (FIG. 3). In the inkjet-recording method 1, printing is carried out with ink on an inkjet-recording medium whose ink-receiving layer has previously impregnated with an acidic substance-containing treatment liquid. Meanwhile, in the inkjet-recording method 2, an acidic substance-containing treatment liquid is applied (pre-coated) onto an inkjet-recording medium, and then printing is carried out with ink.

### —Treatment Liquid—

Examples of the acidic substance, which can be used for making the treatment liquid acidic, include phosphoric acid group-containing compounds, phosphonic acid group-containing compounds, phosphinic acid group-containing compounds, sulfuric acid group-containing compounds, sulfonic acid group-containing compounds, sulfinic acid, carboxylic acid and salts thereof. In particular, phosphoric acid group-containing compounds and carboxylic acid are preferred, with carboxylic acid being more preferred. Examples of the carboxylic acid include compounds having a carboxyl group as a functional group and having a structure of furan, pyrrole, pyrroline, pyrrolidone, pyrone, thiophene, indole, pyridine or quinoline. Specific examples include pyrrolidonecarboxylic acid, pyronecarboxylic acid, pyrrolecarboxylic acid, furancarboxylic acid, pyridinecarboxylic acid, coumalic acid, thiophenecarboxylic acid and nicotinic acid. These compounds, derivatives thereof, or salts thereof are added to the treatment liquid.

Among the above acidic substances, preferred are pyrrolidonecarboxylic acid, pyronecarboxylic acid, furancarboxylic acid, coumalic acid, derivatives thereof, and salts thereof. These compounds may be used alone or in combination.

The treatment liquid may contain other additives, so long as the effects of the present invention are not impeded. Examples thereof include known additives such as dry preventing agents (wetting agents), color-fading preventing agents, emulsion stabilizers, permeation promoters, UV ray absorbers, antiseptic agents, antifungal agents, pH adjusters, surface tension adjusters, defoamers, viscosity adjusters, dispersants, dispersion stabilizers, anticorrosion agents and chelating agents.

### —Ink—

The ink is used for not only monochromatic-image formation but also full-color-image formation. In forming full-color images, magenta ink, cyan ink and yellow ink are used. Further, black ink may be used for adjusting the color tone. In addition to yellow-, magenta-, cyan-inks, there can be used red-, green-, blue-, white-inks and so-called special color inks (e.g., colorless ink) used in the printing field. Examples of the ink include those containing latex particles, organic pigments, a dispersant, a water-soluble organic solvent, and if necessary, containing other additives.

### EXAMPLES

The present invention will next be described in detail by way of examples, which should not be construed as limiting the present invention thereto.

In the Examples, unless otherwise specified, the units “parts” and “%” are on a mass basis and the “polymerization degree” refers to the “average polymerization degree.”

### Example 1

### Fabrication of Water Non-Absorptive Support

Acacia LBKP (50 parts) and aspen LBKP (50 parts) were beaten to a Canadian Freeness of 300 mL with a disk refiner to give a pulp slurry.

To the above-obtained pulp slurry were added cationic starch (final conc.: 1.3%) (CATO 304L, manufactured by Japan NSC), anionic polyacrylamide (final conc.: 0.15%) (DA4104, manufactured by Seiko PMC CORPORATION), alkylketene dimer (final conc.: 0.29%) (Sizepine K, manufactured by Arakawa Chemical Industries, Ltd.), epoxidized amide behenate (final conc.: 0.29%), polyamide polyamine epichlorohydrin (final conc.: 0.32%) (Arafix 100, manufactured by Arakawa Chemical Industries, Ltd.). Subsequently, an antifoaming agent (final conc.: 0.12%) was added to the resultant mixture.

The above-prepared pulp slurry was made into paper using a Fourdrinier paper machine. In this papermaking, the felt surface of the web was dried through pressing against a drum dryer cylinder via a dryer canvas at a dryer canvas tension of 1.6 kg/cm. Thereafter, the raw paper was coated, using a size press, on its both surfaces with polyvinyl alcohol (KL-118, manufactured by Kuraray Company Ltd.) at 1 g/m², followed by drying and calendering, to thereby prepare raw paper (base paper) with a basis weight of 166 g/m² and thickness of 160 μm.

After the wire surface of the base paper had been corona-discharged, high-density polyethylene was coated to a thickness of 30 μm with a melt-extruder, to thereby form a thermoplastic resin layer (hereinafter the surface on which the thermoplastic resin layer was formed is referred to as a “back surface”). The thermoplastic resin layer on the back surface was further corona-discharged, and then coated with an aqueous dispersion to a dry weight of 0.2 g/m². Here, this aqueous dispersion had been prepared by dispersing aluminum oxide (“Alumina Sol 100”) and silicon dioxide (“Snowtex O”) (these products serves as an antistatic agent and are available from Nissan Chemical Industries Co., Ltd.) at a ratio by mass of 1:2.

Furthermore, the felt surface, on which no thermoplastic resin layer had been formed, was corona-discharged. Separately, a low-density polyethylene with a melt flow rate (MFR) of 3.8 was prepared so that the anatase-type titanium dioxide content, the ultramarine blue pigment (product of TOKYO PRINTING INK MEG. CO., LTD.) content, the fluorescent whitening agent “Whiteflour PSN conc” (product of Nippon Chemical Industrial Co., LTD.) content were adjusted to 10%, 0.3% and 0.08%, respectively. The thus-prepared polyethylene was extruded with a melt-extruder to form a high-gloss thermoplastic resin layer (thickness: 25 μm) on the felt surface of the base paper (hereinafter the high-gloss surface is referred to as a “front surface”), whereby a water non-absorptive support was produced. The thus-produced water non-absorptive support was processed to be a long roll product with a width of 1.5 m and winding length of 3,000 m.

This water non-absorptive support was subjected to the water absorption test stipulated in JIS P8140 (water contact time: 15 sec), and it was found to have a Cobb-water absorption degree of 0 g/m². In the water absorption test according to JIS P8140, one surface of a water non-absorptive support was brought into contact with water in a certain time, and the amount of water absorbed by the support was measured. Note that the contact time was set to 15 sec.

### <Preparation of Ink-Receiving Layer-Forming Liquid>

An ink-receiving layer-forming liquid was prepared from the below-listed components as follows: (1) vapor-phase-method silica microparticles, (2) ion-exchange water, (3) “Shallol DC-902P” and (4) “ZA-30” were mixed one another; the mixture was dispersed with a beads mill (e.g., KD-P (product of Shinmaru Enterprises Corporation)); the dispersion was heated to 45° C. and maintained for 20 hours; and (5) boric acid, (6) polyvinyl alcohol solution, (7) “SUPERFLEX 600” and (8) ethanol were added to the dispersion at 30° C.

The ratio by mass of silica microparticles to water-soluble binder (PB ratio or (1):(6)) was 4.45:1, and the pH of the ink-receiving layer-forming liquid was found to be acidic: 3.8.

### <Composition of Ink-Receiving Layer-Forming Liquid>

(1) Vapor-phase-method silica microparticles (AEROSIL 300SF75, manufactured by Nippon Aerosil Co., Ltd.) (average primary particle diameter: 7 nm) (inorganic microparticles): 8.9 parts
(2) Ion-exchange water: 51.4 parts
(3) “Shallol DC-902P” (manufactured by Dai-ichi Kogyo Seiyaku Co., Ltd.) (51.5% aqueous solution) (dispersant, cationic polymer): 0.78 parts
(4) “ZA-30” (manufactured by Daiichi Kigenso Kagaku Kogyo Co., Ltd.) (water-soluble polyvalent metal salt): 0.48 parts
(5) Boric acid (crosslinking agent): 0.33 parts
(6) Polyvinyl alcohol (water-soluble binder) solution: 28.6 parts
(7) “SUPERFLEX 600” (manufactured by Dai-ichi Kogyo Seiyaku Co., Ltd.): 1.11 parts
(8) Ethanol: 4.1 parts

### —Composition of (6) Polyvinyl Alcohol Solution—

The above (6) polyvinyl alcohol (water-soluble binder) solution has the following composition.

(a) “PVA235” (manufactured by Kuraray Company Ltd.) (saponification degree: 88%, polymerization degree: 3,500): 2.0 parts
(b) Ion-exchange water: 26.6 parts

### <Production of Inkjet-Recording Medium>

The front surface of the above-produced water non-absorptive support was corona-discharged. The ink-receiving layer-forming liquid was mixed with a mordant-mixed solution having the following composition to prepare a coating liquid (first liquid) (coating liquid preparation step). In parallel with this preparation, the coating liquid was coated on the support surface (coating step) so that the coating amounts of the ink-receiving layer-forming liquid and the mordant-mixed solution were 35 mL/m² and 2.2 mL/m², respectively. The coated layer was dried with a hot-air dryer (air-blow speed: 3 m/sec to 8 m/sec) at 80° C. until the solid content of the layer reached 24% (note that the coated layer was dried at a constant speed). Immediately thereafter, the support was immersed in a second liquid having the following composition for 3 sec so that the coated layer was coated with the second liquid at 13 g/m² (step of applying mordant solution), followed by drying at 72° C. for 10 min (drying step).

### <Composition of Mordant-Mixed Solution>

(1) Basic polyaluminum hydroxide compound (water-soluble polyvalent metal compound) (Alfine 83, manufactured by TAIMEI CHEMICALS CO., LTD.): 4.0 parts
(2) Ion-exchange water: 4.6 parts
(3) Polyoxyethylene lauryl ether (“Emulgen 109P,” manufactured by Kao Corp. (10% aqueous solution), HLB value: 13.6) (surfactant): 0.7 parts
(4) Hymax SC-505 (manufactured by HYMO Co., Ltd.) (cationic polymer): 0.7 parts

### <Composition of Second Liquid>

(1) Boric acid: 0.65 parts
(2) Ammonium carbonate (1st grade, manufactured by Kanto Kagaku Co. Inc.): 4.0 parts
(3) Ion-exchange water: 89.4 parts
(4) Polyoxyethylene lauryl ether (“Emuigen 109P,” manufactured by Kao Corp. (10% aqueous solution), HLB value: 13.6) (surfactant): 6.0 parts

### <Evaluation of Inkjet-Recording Medium>

The inkjet-recording medium produced in Example 1 was subjected to the following “measurement of ink-absorption capacity,” “measurement of void volume ratio,” “jetting test,” “absorbability test,” “dye-ink jetting test,” “brittleness test” and “curling test.” The results are shown in Table 1.

### <<Measurement of Ink-Absorption Capacity>>

The inkjet-recording medium (inkjet-recording sheet) was cut into test pieces of 10 cm×10 cm, and diethylene glycol (1 mL) was dropped on the ink-receiving layer of each test piece. Thereafter, unabsorbed diethylene glycol remaining on the layer was wiped up, and the ink-absorption capacity (mL/m²) was calculated from the specific gravity of ethylene glycol and the difference between the masses before and after drop.

### <<Measurement of Void Volume Ratio>>

A cross-section of the ink-receiving layer was observed with an electron microscope to determine the layer thickness, and the void volume ratio was calculated from the obtained thickness and the above ink-absorption capacity.

### <<Jetting Test>>

### —Preparation of Ink—

### (1) Preparation of Cyan Pigment Ink C

### (Preparation of Pigment Dispersion)

Cyanine Blue A-22 (PB 15:3) (10 g) (product of Dainichiseika Color & Chemicals Mfg. Co., Ltd.), a low-molecular-weight dispersant 2-1 (10.0 g), glycerin (4.0 g) and ion-exchange water (26 g) were stirred/mixed to prepare a dispersion. Subsequently, using an ultrasonic wave irradiation apparatus (Vibra-cell VC-750, tapered microtip: 5 mm in diameter, Amplitude: 30%, product of SONICS Co.), the thus-prepared dispersion was intermittently irradiated with ultrasonic waves (irradiation: 0.5 sec, intermittence: 1.0 sec) for 2 hours for further dispersing pigment, to thereby prepare a 20% by mass pigment dispersion. Note that the low-molecular-weight dispersant 2-1 has the following chemical structure:

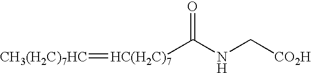

Separately, the following compounds were weighed and stirred/mixed to prepare Mixture I.

### Glycerin: 5.0 g

Diethylene glycol: 10.0 g
ORFIN E1010 (manufactured by Nissin Chemical Industry Co., Ltd.): 1.0 g Ion-exchange water: 11.0 g

Mixture I was gradually added dropwise to a 44% SBR dispersion (polymer microparticles: acrylic acid (3% by mass), glass transition temperature (Tg): 30° C.) (23.0 g) under stirring to prepare Mixture II.

Mixture II was gradually added dropwise to the above-prepared 20% by mass pigment dispersion under stirring to prepare cyan pigment ink C (cyan ink) (100 g). The thus-prepared pigment ink C was measured for its pH value with a pH meter WM-50EG (product of DKK TOA CORPORATION), and was found to have a pH of 8.5.

### (2) Preparation of Magenta Pigment Ink M

The procedure performed in the preparation of cyan pigment ink C was repeated, except that Cyanine Blue A-22 was changed to Cromophtal Jet Magenta DMQ (PR-122) (product of Ciba Speciality Chemicals), to thereby prepare magenta pigment ink M (magenta ink). The thus-prepared pigment ink M was measured for its pH value with a pH meter WM-50EG (product of DKK TOA CORPORATION), and was found to have a pH of 8.5.

### (3) Preparation of Yellow Pigment Ink Y

The procedure performed in the preparation of cyan pigment ink C was repeated, except that Cyanine Blue A-22 was changed to Irgalite Yellow GS (PY74) (product of Ciba Speciality Chemicals), to thereby prepare yellow pigment ink Y (yellow ink). The thus-prepared pigment ink Y was measured for its pH value with a pH meter WM-50EG (product of DKK TOA CORPORATION), and was found to have a pH of 8.5.

### (4) Preparation of Black Pigment Ink K

The procedure performed in the preparation of cyan pigment ink C was repeated, except that Cyanine Blue A-22 was changed to a dispersion CAB-O-JETTM_{—}200 (carbon black) (product of CABOT Co.), to thereby prepare black pigment ink K (black ink). The thus-prepared pigment ink K was measured for its pH value with a pH meter WM-50EG (product of DKK TOA CORPORATION), and was found to have a pH of 8.5.

### —Preparation of Treatment Liquid—

A treatment liquid was prepared by mixing the following components.

Phosphoric acid: 10 g

Glycerin: 20 g

Diethylene glycol: 10 g

ORFIN E1010 (manufactured by Nissin Chemical Industry Co., Ltd.): 1 g

Ion-exchange water: 59 g

The thus-prepared first treatment liquid was measured for its pH value with a pH meter WM-50EG (product of DKK TOA CORPORATION), and was found to have a pH of 1.0.

### —Jetting Method—

Using the above-prepared cyan pigment ink C, magenta pigment ink M, yellow pigment ink Y, black pigment ink K and treatment liquid, single-pass image formation (with four color inks) was carried out with an apparatus as shown in FIG. 3 under the following conditions.

### ——Head for Treatment Liquid in Pre-Coat Module——

Head: piezo full-line head (600 dpi/20 inch width)

Amount of droplet discharged: 0 μL and 4.0 μL used for recording

Drive frequency: 15 kHz (conveyance speed of recording medium: 635 mm/sec)

Printed pattern: treatment liquid is previously applied onto a portion where printing is to be carried out with at least one color ink in the ink-printing step

### ——Water Dry (Air Dry) for Pre-Coat Module——

Air-blow speed: 15 m/s

Temperature: recording medium is heated from its back surface with a contact-type flat heater so that the temperature of the front surface reaches 60° C.

Air-blew area: 450 mm (drying time: 0.7 sec)

### ——Ink-Printing——

Head: piezo full-line heads for four colors (1,200 dpi/20 inch width)

Amount of droplet discharged: 0 μL, 2.0 μL, 3.5 μL and 4.0 μL used for recording

Drive frequency: 30 kHz (conveyance speed of recording medium: 635 mm/sec)

### ——Drying (Water Dry, Air Dry)——

Air-blow speed: 15 m/s

Temperature: 60° C.

Air-blew area: 640 mm (drying time: 1 sec)

### ——Fixation——

Silicone rubber rollers (hardness: 50°, nip width: 5 mm)

Roller temperature: 90° C.

Pressure: 0.8 MPa

### —Evaluation Method—

Gray-scale images and character images were printed out, and the printed images were evaluated through visual observation according to the following criteria.

### [Criteria]

A: Neither image bleeding nor color mixing observed, and 4 pt or smaller [symbol] resolved
B: Neither image bleeding nor color mixing observed, and 5 pt [symbol] resolved
C: Image bleeding and color mixing considerably observed, and low applicability to practical use
D: Image bleeding and color mixing severely observed, and very low applicability to practical use

### <<Evaluation for Absorbability>>

The absorbability was evaluated by determining whether or not a high-boiling-point solvent, etc. remained on printed samples used in the above evaluation (jetting test). Specifically, tissue paper was pressed against the surface of each printed sample, and the tissue paper was visually observed as to whether or not the pigment or the solvent of ink was transferred.

### —Evaluation Criteria—

A: Neither ink solvent nor pigment transferred
B: Only ink solvent slightly transferred, but practically non-problematic
C: Ink solvent considerably transferred, and practically non-allowable
D: Both ink solvent and pigment transferred, and non-allowable

### <<Dye Ink-Jetting Test>>

A printer A820 (product of SEIKO EPSON CORPORATION) was caused to print 5 pt to 24 pt characters on the inkjet-recording medium produced in Example 1, and the quality of the printed characters was visually observed for evaluation.

### —Evaluation Criteria—

A: 5 pt characters not bleed and clearly legible
B: 5 pt characters slightly bleed, but clearly legible
C: 8 pt characters legible (5 pt to 7 pt characters not legible)
D: Characters severely bleed, and unsuitable for printing of characters

### <<Brittleness Evaluation>>

The above-produced inkjet-recording medium was cut into sheets of 2 cm×10 cm, and each of the cut sheets was placed in a constant temperature-humidity chamber (10° C., 20% RH) for 1 day for humidity conditioning. Thereafter, the resultant sheet was rolled up with the ink-receiving layer facing outside, and evaluated for its brittleness. Here, the smaller the diameter of the cylindrical sheet, the higher the occurrence frequency of cracking of the ink-receiving layer. Thus, the diameter of the cylindrical sheet at the time when cracking occurred was defined as a value indicating its brittleness.

### —Evaluation Criteria—

A: Less than 2 cm diameter when cracking occurred, and very low brittleness
B: 2 cm to 3 cm diameter when cracking occurred, and involving almost no practical problems
C: 3 cm to 4 cm diameter when cracking occurred, and problematic cracking occurs during printing with some printers
D: More than 4 cm diameter when cracking occurred, and practically non-allowable

### <<Curling Evaluation>>

The inkjet-recording medium (inkjet-recording sheet) was cut into test pieces of 8.9 mm (width)×12.7 mm (length (coating direction)), and each test piece was left to stand still at 23° C. and 20% RH for 24 hours. Thereafter, the maximum curl heights at the corners were measured, and the obtained values were averaged.

### —Evaluation Criteria—

A: 0 mm to 2 mm of the average of the maximum curl heights with the ink-receiving layer being faced up, and 0 mm to 10 mm of the average of the maximum curl heights with the ink-receiving layer being faced down
B: 3 mm to 9 mm of the average of the maximum curl heights with the ink-receiving layer being faced up
C: More than 10 mm of the average of the maximum curl heights with the ink-receiving layer being faced up

### Comparative Example 1

The procedure of Example 1 was repeated, except that the coating amounts of the ink-receiving layer-forming liquid and the mordant-mixed solution were 173 mL/m² and 10.8 mL/m², respectively, to thereby produce an inkjet-recording medium of Comparative Example 1.

Similar to Example 1, the inkjet-recording medium produced in Comparative Example 1 was subjected to the following “measurement of ink-absorption capacity,” “measurement of void volume ratio,” “jetting test,” “absorbability test,” “dye-ink jetting test,” “brittleness test” and “curling test.” The results are shown in Table 1.

### Comparative Example 2

The procedure of Example 1 was repeated, except that the coating amounts of the ink-receiving layer-forming liquid and the mordant-mixed solution were 70 mL/m² and 4.4 mL/m², respectively, to thereby produce an inkjet-recording medium of Comparative Example 2.

Similar to Example 1, the inkjet-recording medium produced in Comparative Example 2 was subjected to the following “measurement of ink-absorption capacity,” “measurement of void volume ratio,” “jetting test,” “absorbability test,” “dye-ink jetting test,” “brittleness test” and “curling test.” The results are shown in Table 1.

### Example 2

The Procedure of Example 1 was Repeated, Except that the Ink-Receiving layer-forming liquid was changed to an ink-receiving layer-forming liquid having the following composition, and that the coating amount of the ink-receiving layer-forming liquid was changed to 50 mL/m², to thereby produce an inkjet-recording medium of Example 2.

### <Composition of Ink-Receiving Layer-Forming Liquid>

(1) Vapor-phase-method silica microparticles (AEROSIL 300SF75, manufactured by Nippon Aerosil Co., Ltd.) (average primary particle diameter: 7 nm) (inorganic microparticles): 8.9 parts
(2) Ion-exchange water: 51.4 parts
(3) “Shallol DC-902P” (manufactured by Dai-ichi Kogyo Seiyaku Co., Ltd.) (51.5% aqueous solution) (dispersant, cationic polymer): 0.78 parts
(4) “ZA-30” (manufactured by Daiichi Kigenso Kagaku Kogyo Co., Ltd.) (water-soluble polyvalent metal salt): 0.48 parts
(5) Boric acid (crosslinking agent): 0.33 parts
(6) Polyvinyl alcohol (water-soluble binder) solution: 48 parts
(7) “SUPERFLEX 600” (manufactured by Dai-ichi Kogyo Seiyaku Co., Ltd.): 1.11 parts
(8) Ethanol: 20 parts

### —Composition of Polyvinyl Alcohol Solution—

The above (6) polyvinyl alcohol (water-soluble binder) solution has the following composition.

(a) “PVA235” (manufactured by Kuraray Company Ltd.) (saponification degree: 88%, polymerization degree: 3,500): 2.0 parts
(b) Ion-exchange water: 26.6 parts

Similar to Example 1, the inkjet-recording medium produced in Example 2 was subjected to the following “measurement of ink-absorption capacity,” “measurement of void volume ratio,” “jetting test,” “absorbability test,” “dye-ink jetting test,” “brittleness test” and “curling test.” The results are shown in Table 1.

### Comparative Example 3

The procedure of Example 1 was repeated, except that the coating amounts of the ink-receiving layer-forming liquid and the mordant-mixed solution were 8.7 mL/m² and 0.5 mL/m², respectively, to thereby produce an inkjet-recording medium of Comparative Example 3.

Similar to Example 1, the inkjet-recording medium produced in Comparative Example 3 was subjected to the following “measurement of ink-absorption capacity,” “measurement of void volume ratio,” “jetting test,” “absorbability test,” “dye-ink jetting test,” “brittleness test” and “curling test.” The results are shown in Table 1.

TABLE 1

| | Ink-absorption | | | | Dye-ink | | |
|---|---|---|---|---|---|---|---|
| | capacity | Void volume | Jetting | | jetting | | |
| | (mL/m²) | ratio (%) | test | Absorbability | test | Brittleness | Curling |
| Ex. 1 | 6 | 65 | A | A | B | A | A |
| Comp. Ex. 1 | 23 | 64 | C | A | A | D | C |
| Comp. Ex. 2 | 12 | 65 | B | A | A | C | B |
| Ex. 2 | 6 | 42 | B | B | B | B | A |
| Comp. Ex. 3 | 1 | 66 | B | C | C | A | A |

As shown in Table 1, inkjet-recording media having an ink-receiving layer with an ink-absorption capacity of 2 mL/m² to 8 mL/m² (Examples 1 and 2) were found to prevent generation of curling and cracking and to maintain image quality and ink-absorbability.

The inkjet-recording medium having an ink-receiving layer with a void volume ratio of 50% or higher (Example 1) was found to further prevent cracking generation and to further improve image quality and ink-absorbability.

Also, in the inkjet-recording media having an ink-receiving layer with an ink-absorption capacity of 12 mL/m² or more (Comparative Examples 1 and 2), the results in “jetting test” were inferior to those in “dye-ink jetting test.” In contrast, in the inkjet-recording media having an ink-receiving layer with an ink-absorption capacity of 2 mL/m² to 8 mL/m² (Examples 1 and 2), the results in “jetting test” were comparable or superior to those in “dye-ink jetting test.” Thus, inkjet-recording media having an ink-receiving layer with an ink-absorption capacity of 2 mL/m² to 8 mL/m² were found to be particularly suitable for inkjet recording using an inkjet recording system where an acidic substance-containing treatment liquid was applied (such a system was used in the “jetting test”).

1-3. (canceled)

4. An inkjet-recording method comprising:
printing on an inkjet-recording medium with ink in accordance with given image data, and
drying for removing the solvent of ink that has been printed on the inkjet-recording medium,
wherein the inkjet-recording medium includes a water non-absorptive support, and
an ink-receiving layer which is formed over at least one surface of the water non-absorptive support and which contains inorganic microparticles,
wherein the ink-receiving layer has an ink-absorption capacity of 2 mL/m² to 6 mL/m².

5. (canceled)
